(19) United States
(12) Patent Application Publication
(10) Pub. No.: US 2010/0017694 A1
(43) Pub. Date: Jan. 21, 2010

(54) APPARATUS, AND ASSOCIATED METHOD, FOR CREATING AND ANNOTATING CONTENT

(75) Inventors: COREY W. WICK, DALLAS, TX (US); PHILIP C. HANSES, EAST LANSING, MI (US)

Correspondence Address: HEWLETT-PACKARD COMPANY;Intellectual Property Administration, 3404 E. Harmony Road, Mail Stop 35, FORT COLLINS, CO, 80528, US

(73) Assignee: ELECTRONIC DATA SYSTEMS CORPORATION, PLANO, TX (US)

(21) Appl. No.: 12/176,156

(22) Filed: Jul. 18, 2008

(51) Int. Cl. G06F 17/00

(52) U.S. Cl. 715/201

(57) ABSTRACT

An apparatus, and an associated method, for facilitating creation and review of content. An accessor accesses content that is to be reviewed. If the review is to be made using media of a type different than the stored content, a converter converts the content into a desired media. And, reviewing of the content is carried out by way of a user interface. When a reviewer elects to add an annotation to the content, the annotation is made by way of the user interface. If the content is reviewed in textual form, the annotation is made by adding text to the reviewed content and, if the content is reviewed in audio form, the annotation is made as an audio annotation. Once annotation is made and review is completed, the content, together with the annotation made thereto, is stored, available for subsequent viewing or further review.

The present invention relates generally to a manner by which to annotate content in a manner permitting the content and the annotation made thereto subsequently to be viewed. More particularly, the present invention relates to an apparatus, and an associated method, by which to annotate content delivered in a first media type and subsequently to view the content, and the annotation made to the content, delivered an other media type.

Once added to the content, the annotation is accessible irrespective of the media-type in which the content and the annotation made thereto is reviewed. An audio annotation made to the content in audio form is subsequently reviewable in textual, or other, form. And, textual annotation made to the content in textual form is subsequently reviewable in audio, or other, form.

### BACKGROUND OF THE INVENTION

In many industries, productive output is, in significant part, based, not upon the output of manufactured goods, but upon the creation of information. As society becomes increasingly information-based, the creation of information as a productive output shall likely increasingly become a measurement of productive output of enterprise activity. The information forms content, and content is embodied in any of various media-types. For instance, the content is embodied in textual form, visual form, audio form, and combinations thereof, viz., in multimedia form.

The content is created, and, sometimes, prior to finalization of the content, the content is reviewed, modified, either through adding additional content or deletion of content. The content is sometimes also, or otherwise, commented-upon or discussed to consider changing the content. Any change to the content is referred to herein as annotation of the content. When in textual form, for instance, once drafted, the content is sometimes reviewed, either by the creator of the content or others who review the created content. Review of the information, presented in textual form, sometimes results in the reviewer adding notes to, or otherwise modifying, the content. When in paper form, for instance, the reviewer sometimes adds comments in the margins of the paper document. Or, reference is made to a separate paper, or other, document. And, the annotations are detailed on the separate document. When electronically presented, such as by way of a computer word processing application, the annotations are sometimes made in an analogous manner. Comments are, e.g., added by embedding added comments into an updated draft of the content. Microsoft Word™, for example, also provides for tracking of changes made to the draft document, such as underlining to identify added text and strike-through lining of deleted content. Other word processing applications provide analogous types of reviewing tools. Annotations are made to add content, delete content, make remarks, or in any way alter the content.

In general, existing annotation tools provide for the annotation of textual content using textual-based annotations. That is to say, both the creation and review of the content are within a specific media type. And, subsequently, the annotations, i.e., comments and the like, added by way of the textual media are reviewable only by way of the same, or other, tools that access and manipulate text. At best, an annotation within one textual application is readable through use of another textual application.

Such applications are also generally limited to content presented in textual form. Content displayed or viewed in other media, such as audio media, cannot generally be annotated. To the extent that existing mechanisms provide for annotation of content in an audio format, the annotations are generally restricted to only the original content or, at best, in periodically released versions of new recordings that are made to reflect the annotations or other changes, made to the content. And, access and review generally remains restricted to audio media presentation.

Text-to-speech (TTS) and speech-to-text (STT) technologies have, in recent years, been introduced and used to convert content between media types. That is to say, a text-to-speech converter converts content from textual to audio format, and speech-to-text converter converts content from audio to textual format. While such converters are available, they have not generally been used in the context of content collaboration in which annotation is made to content, such as pursuant to review of the content.

If a manner could be provided by which to utilize such converters in the review of content in which annotation is made to the content, increased review flexibility would be provided.

It is in light of this background information related to content annotation that the significant improvements of the present invention have evolved.

### SUMMARY OF THE INVENTION

The present invention, accordingly, advantageously provides an apparatus, and an associated method, by which to create and to annotate content in a manner permitting the content and annotation thereto subsequently to be viewed.

Through operation of an embodiment of the present invention, a manner is provided by which to annotate content delivered as a first media type and subsequently to review the content, and make annotation to the content, when delivered in any of the first or other media type.

In one aspect of the present invention, the annotation, once made to the content, is subsequently accessible irrespective of the media-type used to review the content and the annotation made thereto. That is to say, an audio annotation made to the content presented in audio form is subsequently reviewable in textual, or other, form. Similarly, textual annotation made to content presented in textual form is subsequently reviewable in audio, or other, form.

In another aspect of the present invention, the content is delivered to a content reviewer that provides for user reviewing of the delivered content. The content is delivered in a media-type, or is converted into a media-type, that permits its reviewing by a reviewer. When delivered in audio media type, and the content is to be reviewed as textual media, a speech-to-text converter converts the content into textual form. Analogously, if the content is to be reviewed as audio media, and the content is delivered in textual form, a speech-to-text converter is used to convert the content into audio media.

In another aspect of the present invention, an accessor accesses the content that is reviewed by the reviewer. The content is accessed in a manner permitting the reviewer to select locations of the content at which to make annotation to the content.

In another aspect of the present invention, an annotator is provided by which to permit annotation to be made to the reviewed content. The annotator operates to make annotation to the content at a location of the content selected by the reviewer. A user interface, e.g., is used by the reviewer to identify at where in the reviewed content that the annotation is to be made. And, the user interface is used by the reviewer also to enter the annotation, i.e., to add, delete, modify, or comment upon content. When the content is viewed as textual media, for instance, the user interface includes an input keyboard or other input actuator that permits the annotation to be entered by the reviewer through actuation of the input actuator. When the content is viewed as audio media, the user interface includes an audio transducer to transduce acoustic input into electrical, audio form. When the content includes visual media, such as a multimedia presentation, the user interface includes a visual transducer, i.e., a display screen, for viewing the visual-media part of the content.

In another aspect of the present invention, annotations made to the content are of any of various types, e.g., revisions, comments, images, etc. If the annotations are made verbally, the audio annotations are translatable to text, added, e.g., as a notation at a point in which the annotation is made. Likewise, an annotation made through a textual media is translatable to audio, notated, e.g., by a special tone, or other indication that identify its addition to a reviewer that reviews the content when presented in the audio form.

In another aspect of the present invention, source content is stored at a content database. Content that is to be reviewed is identified and access, such as by reading the selected content from the content database. The content database is accessed in any of various manners including, e.g., by way of remote access through network connections. When accessed remotely, authentication procedures are carried out to ensure that the requester of the content is authorized to access the content.

In another aspect of the present invention, once accessed, a decision is made, or an indication is also provided in what media that the content is to be reviewed. If the accessed content is to be reviewed in a media other than the media-format in which the content is stored, a converter converts the content into a media appropriate for the reviewer to review the content. If the stored, source content is text-formatted, and the review is to be made by audio review, a text-to-speech converter converts the text-formatted content into audio form. And, when the stored, source content is audio-formatted and the review is to be made in textual form, a speech-to-text converter converts the content into textual form as textual media for review by the reviewer.

In another aspect of the present invention, the reviewer reviews the content presented in the appropriate media. When presented as audio media, the content is played out by an audio player. And, when presented in textual form, the content is displayed as text, readable by the reviewer. When presented in multiple media form, the content is played out or displayed in a manner that permits the reviewer to view all of the content.

In another aspect of the present invention, if the reviewer elects to annotate the content, the reviewer provides indication of the election, such as by way of a user interface, and the annotation is entered at, or in conjunction with or reference to, a location of the content. The entered annotation is entered in the medium selected by the reviewer, such as the medium in which the content is provided for review.

Because the annotation is subsequently reviewable in a media selected by a subsequent reviewer, limitations that are conventionally associated with reviewing applications and mechanisms are obviated.

In another aspect of the present invention, a creator of the content creates content in a first media, stores the content, and then subsequently creates further content, that is, adds additional content to the earlier-created content. The subsequently-added content is able to be added irrespective of whether the earlier-created content was created in a different media than the subsequently-added content. That is to say, the earlier-created content created in the first media is annotated with the later-created content, created in a second media.

In these and other aspects, therefore, an apparatus, and an associated method, is provided for facilitating annotation of source content. An accessor is configured to access the source content delivered in a first selected media type. An annotator is configured to annotate the source content accessed by the accessor. Annotation to the source content permits subsequent viewing thereof when the source content is in any of the first selected media type and an other media type.

### BRIEF DESCRIPTION OF THE DRAWINGS

FIG. 1 illustrates a functional block diagram of an arrangement in which an embodiment of the present invention is operable.

FIG. 2 illustrates an exemplary process diagram representative of operation of an embodiment of the present invention.

FIG. 3 illustrates another exemplary process diagram representative of alternate operation of an embodiment of the present invention.

FIG. 4 illustrates a method flow diagram representative of the method of operation of an embodiment of the present invention.

### DETAILED DESCRIPTION

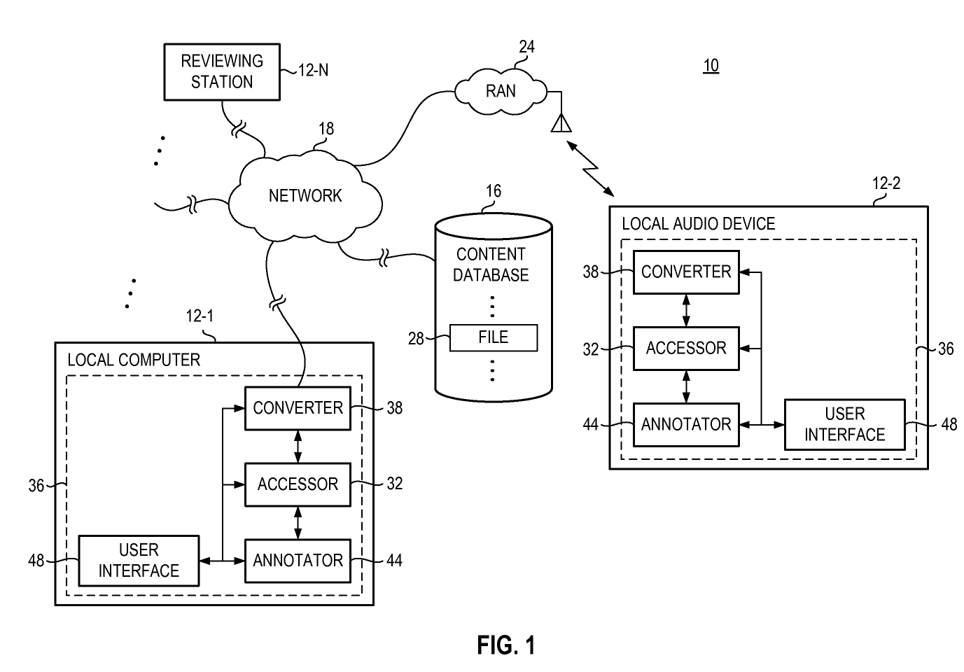

Referring first to FIG. 1, an arrangement, shown generally at 10, provides a plurality of reviewing stations 12 that permit review of content, here content retrieved from a content database 16. In the exemplary implementation, the reviewing stations are at least selectively placeable in communication connectivity with the content database so that content stored thereat is downloadable to, or otherwise retrievable by, the receiving stations. The receiving station 12-1 is placed in communication connectivity with the content database 16 by way of a network 18, such as the internet, a local network, or a combination thereof. And, the receiving station 12-2 is shown to be placed in communication connectivity with the content database by way of the network 18 and a radio link 22 defined by operation of a radio accessed network (RAN) 24. While the following description of exemplary operation of the arrangement 10 shall be described with respect to the configuration shown in FIG. 1, it should be understood that operation of an embodiment of the present invention is also carried out in other configurations including, e.g., a configuration in which content is located together with a reviewing station or in which content is communicated to a receiving station such as by attachment to an email or other delivery mechanism. The content is, e.g., also automatically synchronizable if the reviewing station forms a smart phone when the smart phone is docked at a docking station, or downloadable via the internet through an internet connection, or wirelessly, such as via a Wi-Fi connection. Additionally, while the stations 12 are referred to as reviewing stations, the stations 12 are, of course, also capable of being used pursuant to original creation of content.

The content database stores content that is formatted in any of the various manners and is here stored as database files 28 that are stored in a file-formatted scheme. Each file is a digital rendering, that is to say, a digital representation of the information. The content database 16 in which the files 28 are stored is of any of the various storage capacities. The content database, for instance, is defined at a computer server whose files are created and stored during operation of a business, or other, enterprise. And, more generally, the content database is representative of any origination location at which content that is to be reviewed originates or is stored. In the exemplary implementation in which the content database forms an enterprise, or other, computer server, a file 28 is retrievable therefrom when the requestor is properly authenticated.

By way of example, the reviewing station 12-1 forms a local computer station, such as a desktop computer, or the like, and the reviewing station 12-2 forms an audio play-out and recording device, such a portable digital recorder or a computing station that includes audio play-out and recording capability. As mentioned previously, while there are various mechanisms by which to review and to annotate content, annotation is generally limited to textual annotation and, in any event, subsequent reviewing of annotations, once made, is generally limited to use of the same media type used by which to make the annotations. Subsequent reviewing, or additional reviewing, of the content in a different media has, therefore, conventionally been problematical. For instance, if annotations are made at the reviewing station 12-1 in textual media have typically not been able subsequently to be viewed at the reviewing station 12-2.

Each of the receiving stations 12 includes apparatus 36 of an embodiment of the present invention. The apparatus permits a reviewer of content to make annotation to the content, herein referred to as source content, and provides for subsequent reviewing of the annotation even if the subsequent viewing is made in a different media type. The apparatus 36 here includes a converter 38, an accessor 42, an annotator 44, and user interface 48. The elements of the apparatus are functionally represented, implementable in any desired manner, including, for instance, by algorithms executable by processing circuitry. While the elements of the apparatus are represented, in the exemplary implementation, at a single location, i.e., embodied at a reviewing station, in other implementations, elements are distributed across more than one physical location. That is to say, in other implementations, one or more of the elements of the apparatus are positioned elsewhere, such as at the network 18 or at the database 16.

When source content is to be reviewed, a reviewer that operates a reviewing station selects the content that this to be reviewed or receives the content that is to be reviewed. With respect to operation of the reviewing station 12-1, the reviewer interfaces with the reviewing station by way of the user interface 48. The user interface here comprises, e.g., a computer keyboard or other mechanism that permits the reviewer to enter input information, such as information that identifies the source content that is to be reviewed. The input of the information is provided to the accessor 42, and the accessor operates to access the requested content. In the exemplary implementation, the accessor requests access to the content database to access, and to retrieve, the requested source content. If the content is delivered to the reviewing station, such as by delivery of an email with the source content included or attached thereto, the accessor functions to access the source content from the delivered message. The reviewing station 12-1 is also operable to provide for the original creation of content.

In the event that the content is of a media type different than the media by which the reviewer plans to review the content, the content is converted by the converter 38 into appropriate form. In the illustrated embodiment, the conversion of the media is performed prior to access by the accessor of the content. In another implementation, the content is converted subsequent to its access by the accessor.

Once accessed, the content is reviewed by the reviewer, here by providing the accessed content to a display device of the user interface 48. When the user elects to make annotation to the content, the reviewer elects at where in the displayed content to make the annotation and enters annotation information, i.e., the comments, changes, or other input information, i.e., additions or deletions, that form the annotation. The annotator 44 is configured to receive the input information provided by the reviewer through the input actuator of the user interface to the source content. The annotator makes the annotation, or indexes the annotation, at the location of the content identified by the user by way of the user interface. Multiple annotations, if selected, are made by the annotator responsive to instruction by the reviewer. Upon completion of the review by the reviewer and annotation of the source content, the source content, with the annotations added, is made available for subsequent viewing or subsequent reviewing. In the exemplary implementation, the source content, once the annotations are added, is again stored at the content database 16. Alternately, the reviewed content, with the annotations added, is forwarded to another entity, such as another reviewing station or other computer station.

Here, as the reviewing station comprises a reviewing station that provides for reviewing of the content when reviewed as textual media, the annotations are added as textual media.

Operation of the reviewing station 12-2 and the apparatus 36 thereof is analogous. And, again, the reviewing station 12-2 is also operable pursuant to original creation or content as well as to annotate earlier-created content. Here, e.g., the reviewer elects to review the source content. The source content is either delivered to the reviewing station, such as by way of an attachment to an email or other message, or the reviewer elects to request delivery of the source content through interaction with the user interface 48. The accessor 42 accesses the content that is to be reviewed. If the content elected to be reviewed is stored remotely, such as at the content database 16, the accessor requests access to and downloading from, the database.

Again, a converter 38 operates to convert, if needed, the content into a different media. Here, the reviewing station comprises an audio device, and the content is to be reviewed in audio form. If the source content is delivered as textual media, the converter 38 operates to convert the media into audio form. Conversion is, e.g., performed automatically or by instruction of the reviewer entered by way of the user interface 48. Automatic conversion is carried out, e.g., if the type of media in which the content is embodied when delivered to the receiving station is different than the media-type that the receiving station is capable of displaying or otherwise playing out, the content is automatically converted by the converter into a type of media that is reviewable at the receiving station. If the reviewing station is capable of reviewing the content in more than one type of media, automatic operation is provided using a default selection. Otherwise, the reviewer that operates the reviewing station is provided with a choice of the available options. Again, while the converter functionality 38 is illustrated in front of the accessor functionality 42, in an alternate implementation, conversion is made subsequent to access of the content.

The annotator 44 here, again, annotates the content that is reviewed. When the content is played out as audio media, a speaker, or other acoustic transducer, of the user interface 48 is used to permit the reviewer to listen to the played-out content. When an annotation is to be made, the reviewer enters instructions by way of the user interface and the annotation, here an audio annotation is entered by way of, e.g., a microphone that forms part of the user interface. Once review is completed and annotation is made, the content, including the one or more is made available for subsequent viewing, or further review. The annotated content is, e.g., returned to the content database or forwarded on to another reviewing, or other, station.

Annotation is made as audio media, inserted, e.g., at a location at which the annotation is intended to be made. Subsequent reviewing of the annotated content need not be in audio form. Through use of functionality analogous to the converter 38, audio-formatted content is converted into another media-type and viewed as the media-type content.

The reviewing stations 12-1 and 12-2 are also exemplary of stations operated by a single user at different times. The reviewing station 12-2 is permitting of mobility due to its wireless connectivity. And, the reviewing station, e.g., is implemented as a telematic device, such as an On-Star™ device.

The user is able to initiate drafting, i.e., create, content using the reviewing station, here as audio media. For instance, the content creation is commenced as audio media during a user's commute to a work site. The content, once created, is stored, e.g., at the content database 16.

Later, while at the work site, e.g., the user retrieves the content in textual media through the reviewing station 12-2, here implemented as a computer workstation, and the user continues with content creation in textual form.

Thereby, the content creation carried out at the reviewing station 12-2 comprises annotation, addition to, deletion from, or other modification to the earlier-created content.

Successive modifications, i.e., annotations that add to, delete from, change, comment upon, etc., are able to be made at any of the reviewing stations. The resultant content is, rather than a collaborative work of several different parties, is a collaborative work of a single party, at different times.

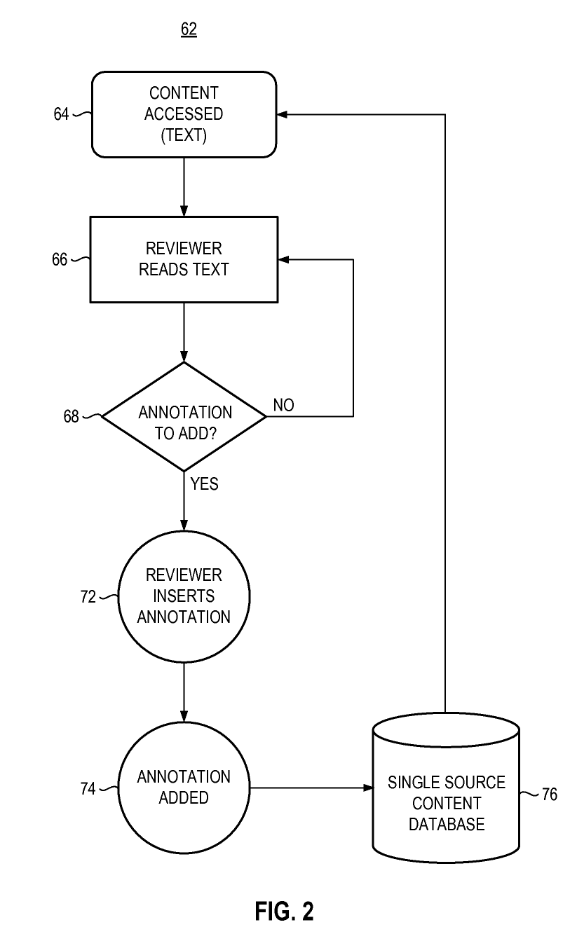

FIG. 2 illustrates a process diagram, shown generally at 62, representative of exemplary operation of an embodiment of the present invention, such as that carried out by the apparatus 36 shown in FIG. 1. Review of content comprising textual media is represented.

First, and as indicated by the block 64, the content is accessed. The content here is already in textual form. Then, and as indicated by the block 66, the reviewer reads the text pursuant to review of the content. And, as indicated by the decision block 68, the reviewer decides whether to add an annotation to the content. If not, the no branch is taken back to the block 66, and reviewing continues. If, instead, a decision is made at the decision bock 68 to add an annotation, the yes branch is taken to the block 72, and the reviewer inserts the annotation. Here, the annotation is also in textual form. In an alternate implementation, the annotation need not be in the same media as the media in which the content is reviewed. In one implementation, audio annotation is made to textual media.

Once the annotation is made, the annotation is added, indicated by the block 74, and the annotated content is stored at the database 76. When multiple annotations are made throughout the content, the steps 66-82 are iteratively performed until the review is completed.

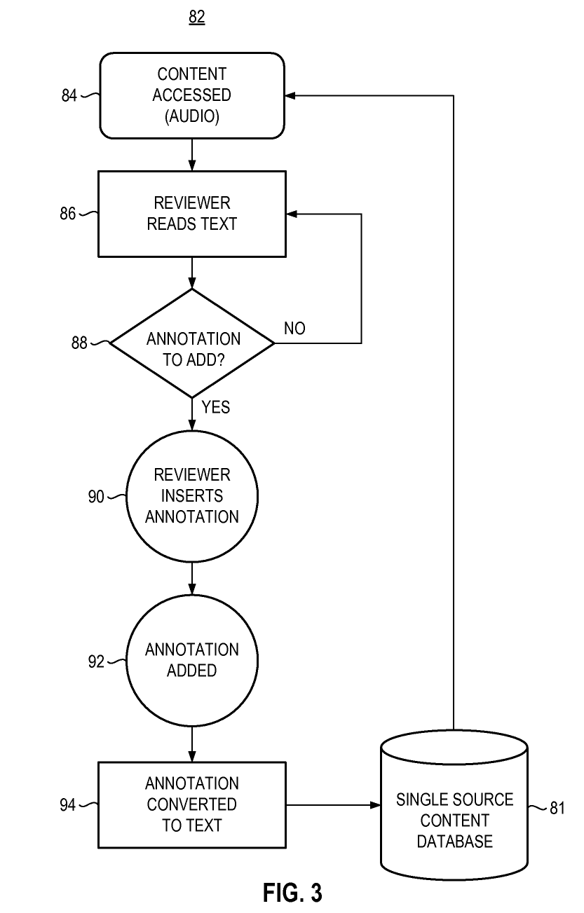

FIG. 3 illustrates a process diagram shown generally at 82. Here, the review of content in audio form is represented.

First, and as indicated by the block 84, the content is accessed, here from the content database 76. Then, and as indicated by the block 86, the reviewer listens to the content as the content is played out.

At the decision block 88, the reviewer decides whether to add an annotation to the content. If not, the no branch is taken back to the block 86. Otherwise, the yes branch is taken to the block 92, and the reviewer inserts an annotation to the content. Once the annotation has been made, the annotation is added, indicated by the block 94 to the content. Then, and as indicated by the block 94, the annotation is converted to text, and the content is stored at the database 76.

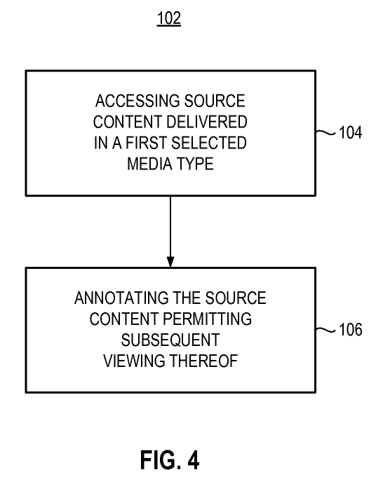

FIG. 4 illustrates a method, shown generally at 102, representative of the method of operation of an embodiment of the present invention. The method facilitates annotation of a source document.

First, and as indicated by the block 104, the source content delivered in a first selected media type is accessed. Then, and as indicated by the block 106, the source content is annotated, once accessed, in a manner that permits subsequent viewing thereof when the source content is in any of the first selected media type and an other media type.

Presently preferred embodiments of the invention and many of its improvements and advantages have been described with a degree of particularity. The description is of preferred examples of implementing the invention and the description of preferred examples is not necessarily intended to limit the scope of the invention. The scope of the invention is defined by the following claims.

What is claimed is:

1. An apparatus for facilitating annotation of a source content, said apparatus comprising:
an accessor configured to access the source content delivered in a first selected media type; and
an annotator configured to annotate the source content accessed by said accessor, annotation to the source content permitting subsequent viewing thereof when the source content is in any of the first selected media type and an other media type.

2. The apparatus of claim 1 wherein the source content comprises textual content.

3. The apparatus of claim 1 wherein the source content comprises aural content.

4. The apparatus of claim 1 wherein the source content comprises video content.

5. The apparatus of claim 1 wherein the source content comprises multimedia content.

6. The apparatus of claim 1 wherein the first selected media type comprises an audio media type.

7. The apparatus of claim 1 wherein the first selected media type comprises a text media type.

8. The apparatus of claim 1 wherein the other media type comprises an audio media type.

9. The apparatus of claim 1 wherein the other media type comprises a text media type.

10. The apparatus of claim 1 wherein said annotator is configured to annotate the source content at a user-selected location in the source content.

11. The apparatus of claim 1 further comprising an annotated-source-content storer configured to store the source content, once annotated by said annotator.

12. The apparatus of claim 1 wherein annotation made by said annotator to the source content is made in the first selected media type.

13. A method for facilitating annotation of a source document, said method comprising:
accessing the source content delivered in a first selected media type; and
annotating the source content, once accessed, in a manner permitting subsequent viewing thereof when the source content is an any of the first selected media type and an other media type.

14. The method of claim 13 further comprising delivering the source content in the first selected media type.

15. The method of claim 14 further comprising converting the source content into the first selected media type.

16. The method of claim 13 further comprising storing the content, once annotated.

17. The method of claim 16 further comprising converting the source content into the other media type.

18. The method of claim 13 further comprising subsequently viewing the source content in the other media type.

19. The method of claim 13 further comprising subsequently viewing the source content in the first selected media type.

20. A method for creating content, said method comprising:
selecting a first one of a first media type and a second media type by which initially to create the content;
creating a first portion of the content in the first one of the first and second media types;
storing the first portion of the content;
selecting a second one of the first media type and the second media type by which further to create the content;
retrieving the first portion of the content; and
creating second portion of the content in the second one of the first and second media types.
